(19) United States
(12) Patent Application Publication
(10) Pub. No.: US 2011/0290207 A1
(43) Pub. Date: Dec. 1, 2011

(54) SYSTEM FOR ENHANCING THE FUEL ECONOMY OF A DIESEL ENGINE

(75) Inventors: Benjamin J. KAUFMAN, Hopewell Junction, NY (US); James R. KETCHAM, Salt Point, NY (US); William P. ACKER, Rexford, NY (US)

(73) Assignee: TACONIC ENERGY, INC., Salt Point, NY (US)

(21) Appl. No.: 12/787,596

(22) Filed: May 26, 2010

(51) Int. Cl. F02B 43/00; F02B 3/00

(52) U.S. Cl. 123/1 A; 123/299

(57) ABSTRACT

Methods and system for enhancing the fuel economy of a diesel engine is disclosed. The system is useable in a four stroke diesel engine to allow a first injection step to be performed whereby fuel is injected into the cylinders of a diesel engine to initiate combustion of the fuel within the cylinder. A second injection step then occurs, whereby an additive is injected into the cylinder, during the cycle but at a time different than the first injection step wherein the additive reaches the cylinder wall. The additive, which reaches the cylinder wall, provides friction modification and fuel economy benefits for a diesel engine.

### FIELD OF THE INVENTION

This invention relates to diesel engines and particularly systems for enhancing the fuel economy of diesel engines.

### BACKGROUND OF THE INVENTION

Fuel additives have been developed which are mixed with fuel and delivered to the cylinders of engines together with the fuel. These fuel additives are useable in spark ignition engines, which run on fuels such as gasoline, oxygenated gasolines, and gasoline ethanol blends. Engines utilizing these fuels typically employ a pre-mixed homogenous combustion, where fuel is uniformly distributed in the combustion chamber thus allowing substantial quantities of the fuel additive to reach the cylinder wall, and thus ultimately engine components. The additive thus provides lubricity and friction modification to reduce the friction within the engine. In addition, these additives can also accumulate in the lubricant sump to continuously provide these performance benefits to the lubricant.

In diesel engines, however, a fueling strategy is typically employed where fuel is injected directly into the combustion chamber in such a way as to minimize the fuel contacting the cylinder walls, the additive is less likely to contact the cylinder wall and improve fuel economy. Therefore, fuel additives typically are more likely to improve the fuel economy of spark injection engines as opposed to diesel engines. It is therefore desirable to utilize a system to improve the fuel economy of diesel engines including diesel engines which employ additives, including fuel additives, intended to provide additional lubricity and friction modification to engine components.

### SUMMARY OF THE INVENTION

In accordance with the principles of the present invention, a system for enhancing the fuel economy of a diesel engine via the introduction of additives is described herein. The system is particularly effective in a diesel engine of the type wherein each cylinder undertakes four strokes during a cycle. The method includes performing a first injection step by injecting fuel into a cylinder of a diesel engine to initiate combustion of the fuel within the cylinder, and performing a second injection step by injecting an additive into the cylinder during the cycle at a time different than the first injection step wherein the additive reaches and contacts the cylinder wall. The first and second injection steps may be repeated during different cycles to improve the fuel economy of the diesel engine.

The method and system of the present invention may be employed such that the second injection step includes injecting the additive when the additive is mixed within fuel, i.e., a fuel additive. The second injection step may occur at a time during a cycle after the piston reaches 40° after compression top dead center and at a time prior to when the piston in the cylinder reaches 10° before compression top dead center. The amount of fuel, cumulatively over time, included in the second injection steps may be less than the amount of fuel injected in the first injection step. The amount of fuel within the second injection step in aggregate, for example, may be less than about 10% of the amount of fuel injected during the first injection step. In some embodiments, the number of second injection steps will be substantially less than the first injection steps and it may be desirable to inject larger amounts in the individual second injection event, while maintaining lower cumulative second injection volume.

A concentration of additive within the fuel in the second injection step may be greater than the concentration of additive within the fuel during a first injection step. The additive may be injected into the fuel stream of the diesel engine at selective time intervals. The selective time intervals may be repeated periodically. The second injection step may be repeated during multiple consecutive cycles. For example, the second injection step may be repeated for up to 30 seconds after about at least 10 minutes of engine operation during which time no second injection step occurs. The method and system may be performed in multiple cylinders of the diesel engine.

In another aspect, the invention includes a system for enhancing the fuel economy of a diesel engine of the type wherein each cylinder undertakes four strokes during a cycle, and of the type having means for performing a first injection step by injecting fuel into a cylinder of a diesel engine to initiate combustion of said fuel within said cylinder. The system includes means for performing a second injection step by injecting an additive into the cylinder during said cycle at a time different than said first injection step wherein the additive reaches the cylinder wall; and means for repeating said first injection step and said second injection step during a different cycle to improve the fuel economy of said diesel engine. The system may incorporate a control means, such as a microprocessor controller, which allows the system to incorporate the above described methods. The additive may be a fuel additive, mixed with fuel.

The method and system of the present invention may be incorporated into a diesel engine of the type wherein each cylinder undertakes four strokes during a cycle. The system includes an engine block having a plurality of cylinders therein; means for performing a first injection step by injecting fuel into at least one of said cylinders to initiate combustion of said fuel within said cylinder near the end of a compression stroke of said cycle; means for performing a second injection step by injecting an additive into the cylinder during said cycle at a time different than said first injection step to allow said additive to reach the cylinder wall; and means for repeating said first injection step and said second injection step during a different cycle to improve the fuel economy of said diesel engine.

These and other aspects of the invention will become evident upon reference to the following detailed description of the invention and accompanying examples.

### BRIEF DESCRIPTION OF THE DRAWINGS

FIG. 1 is a schematic representation of the system for enhancing the fuel economy of the diesel engine in accordance with the principles of the present invention.

FIG. 2 is a sectional view of a cylinder of a type found in a diesel engine incorporating the system for enhancing fuel economy in accordance with the principles of the present invention.

FIG. 3 is graphical representation of the timing of a first injection step and second injection step relative to a crankshaft angle and piston position during a four stroke cycle in accordance with the principles of the present invention.

FIG. 4 is a schematic representation of an alternative embodiment for enhancing the fuel economy of a diesel engine in accordance with the principles of the present invention.

### DETAILED DESCRIPTION OF EMBODIMENTS OF THE INVENTION

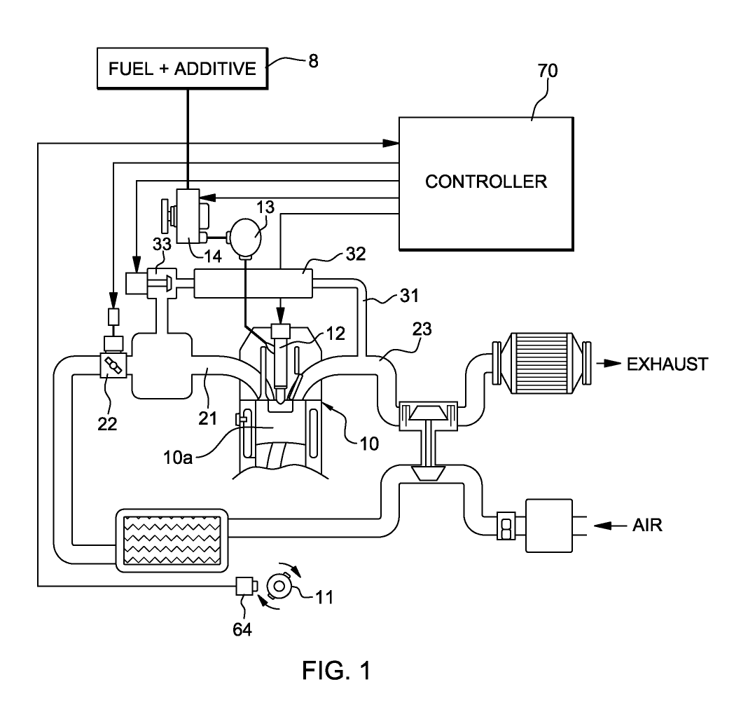

FIG. 1 depicts a schematic representation of a diesel engine implementing the principles of the present invention. A typical diesel engine contains multiple cylinders, for example, 2, 6, 8, 10 or 12 cylinders. The cylinders are typically aligned in either an inline configuration or V-shaped configuration. For simplicity, FIG. 1 depicts a single cylinder 10. However, the present invention may be implemented in any diesel engine containing any number of cylinders.

As shown in FIG. 1, the diesel engine contains one or more cylinders 10 having a fuel injector 12 in operative engagement therewith. The fuel injector 12 is in fluid communication with a common rail 13, which typically contains fuel fed from a fuel pump 14 in fluid communication with the common rail 13. Fuel is typically fed from the fuel pump 14 through the common rail 13, which feeds each cylinder within the diesel engine 10 with fuel via a fuel injector 12.

Air may flow from an air inlet through a turbocharger and air filter and eventually to an electric throttle 22 and intake passage 21 into cylinder 10. Cylinder 10 is in fluid communication with intake passage 21 and exhaust passage 23. After combustion of an air and fuel mixture within the cylinder, exhaust gases generated within the cylinder 10 through exhaust passage 23 and through the turbocharger and eventually through the exhaust system of the diesel engine, which typically includes a diesel particulate filter.

A fuel line feeds fuel pump 14, which is in fluid communication with a fuel tank 8 containing fuel and an additive. Any additive, which provides increased fuel economy by virtue of, for example, its contact with engine components via the cylinder walls may be useable with the method and system of the present invention. One such fuel additive developed by Taconic Energy, Inc. is described in U.S. patent application Ser. No. 12/327,135 filed on Dec. 3, 2008, which is incorporated herewith in its entirety. This additive comprises alkanolamides which are free of esters, or has an amide to ester ratio of greater than 1.4 to 1. Such additives may be obtained from a reaction of a natural or synthetic oil, fatty acids and esters, with alkanolamine. Other additives that provide friction modification including friction modifying esters and amides derived from fatty acids and diacids may be used. However, commercially available acids or simple fatty esters that only act as diesel lubricity agents to reduce pump wear have not been shown to provide fuel economy benefits in spark initiated engines. For this reason they would not be expected to be effective in this application. The additive may be mixed with the fuel, as a fuel additive, within the fuel tank 8 and is transported to the cylinder 10 mixed with fuel via the fuel pump 14, common rail 13 and fuel injector 12.

Each cylinder 10 of the diesel engine is connected by a linkage to a crankshaft 11, which rotates and thereby causes reciprocating strokes of each piston within the cylinders including cylinder 10. The position of any piston within a cylinder may therefore be measured by the angle of rotation of the crankshaft 11 (i.e., crank angle). A crankshaft sensor 64 senses the crank angle of the crankshaft 11 and is connected electronically to a controller 70. The controller is typically a microprocessor, which also controls the fuel pump 14, electric throttle 22, one or more fuel injectors 12 and fuel pump 14.

An exhaust gas recirculation loop 31 is in fluid communication with exhaust passage 23 and intake passage 21. An exhaust gas recirculation (EGR) valve 33 is located within the exhaust gas recirculation loop 31 controls the amount of exhaust gas recirculated into the intake passage during operation of the diesel engine. The controller 70 also controls the operation of the EGR valve 33.

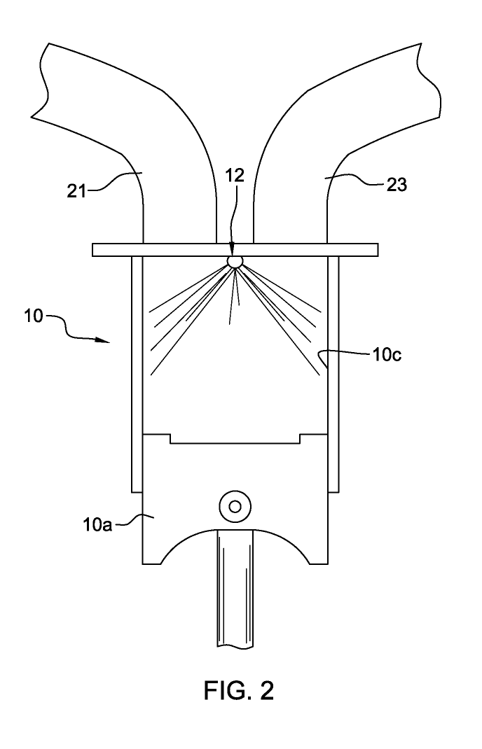

As shown in FIG. 2, each piston 10a within the engine is connected to the crankshaft by a linkage. Referring to FIGS. 1 and 2, the cylinder 10 contains one or more intake valves between intake passage 21 and cylinder 10, and one or more exhaust valves between exhaust passage 23 and cylinder 10. Intake passage 21 allows air to enter the cylinder 10. Air entering into the cylinder passes through and is controlled by one or more intake valves (not shown). Exhaust from within the cylinder exits the cylinder 10 into the exhaust passage 23 via an exhaust valve (not shown).

The piston 10a within each cylinder typically undergoes four strokes during a cycle. Combustion occurs after air and fuel enter the cylinder and when the piston 10a is at or near, or slightly past, compression top dead center. Combustion causes the piston to translate toward the bottom of the cylinder 10 to a crank angle of bottom dead center (or 180° from compression top dead center). The crankshaft 11 then causes the piston 10a to enter the exhaust stroke, which translates the piston 10a towards the top of the cylinder causing the exhaust gases to pass through the exhaust valve and into the exhaust passage 23. At this point, the piston 10a is located at exhaust top dead center. As the crankshaft continues to rotate the piston will begin to translate towards the bottom of the cylinder during the intake stroke where air will enter the cylinder via the intake valve. As the crankshaft 11 continues to rotate the cylinder will reach intake bottom dead center (180° from top dead center) and then begin to translate towards the top of the cylinder 10 during the compression stroke where air within the cylinder will become compressed. Near, or slightly after, the end of the compression stroke, fuel again enters the cylinder 10 through the fuel injector 12 to caused combustion and the start of a new cycle. The four stroke cycle for each piston 10a is continuously repeated as the engine operates.

Near, or slightly after, the end of the compression stroke, described above, a first injection step occurs and fuel from the common rail 13 is injected by the fuel injector 12 into the cylinder 10 to initiate combustion. This combustion is caused by the compression of air with diesel fuel and powers the diesel engine. During the first injection step fuel is injected into the cylinder 10 via the fuel injector 12 at a point where the piston 10a is near compression top dead center. Fuel and additive, which may be mixed within the fuel in this first injection step, is unlikely to reach the cylinder wall 10c. Rather, combustion occurs preferably at a time prior to when any fuel reaches the cylinder wall 10c. Moreover, fuel contacting the cylinder wall 10c during this first injection step is not desirable since uncombusted fuel on the cylinder wall may make its way into the oil within the crankcase and thus dilute the oil's effectiveness.

Preferably, after the first injection step and after the piston stroke reaches 40° from compression top dead center, the second injection step may occur. This second injection step includes fuel additive injected from the fuel injector 12 into the cylinder 10. Because of the location of the piston 10a and flow characteristics within the cylinder due to the operating conditions therein, fuel additive injected into the cylinder contacts the cylinder wall 10c to provide friction modification. The fuel additive, which contacts the cylinder wall may, upon passage of the piston over the cylinder wall, mix with oil within the crankcase below the cylinder and thus provide additional friction modification to various engine components. This allows for increased fuel economy and reduced engine wear within diesel engines.

The second injection step may occur during a different time within the piston cycle. The controller 70 may control this second injection step, as well as the first injection step. The controller 70 controls injecting the additive, which may be mixed within the fuel via the fuel tank 8, into the cylinder through common rail 13 and fuel injector 12. The controller 70 may also control other various engine functions.

The controller 70 receives information regarding the position of the crank angle from the crank angle sensor 64. The controller 70 may then control the timing of the second injection step based upon the information received from the crank angle sensor 64. The controller may be programmed to perform the second injection step at a particular time during the piston cycle for each cylinder within a diesel engine by initiating the second injection step at the desired timing within a piston cycle.

Referring to FIG. 2, the second injection step should occur at a time where the piston 10a is at a location, which allows the fuel additive within the fuel to reach the walls of the cylinder 10. Such a time occurs, for example, after combustion of the fuel/air mixture within the cylinder. Preferably, the second injection step should occur after a piston reaches 40° after compression top dead center and prior to the time when the piston reaches 10% before compression top dead center. The second injection step preferably occurs during the intake or exhaust stroke to facilitate the fuel additive reaching the cylinder walls. Once the fuel additive reaches the cylinder walls, the additive may make its way into the engine oil to provide additional lubricity and increased fuel economy.

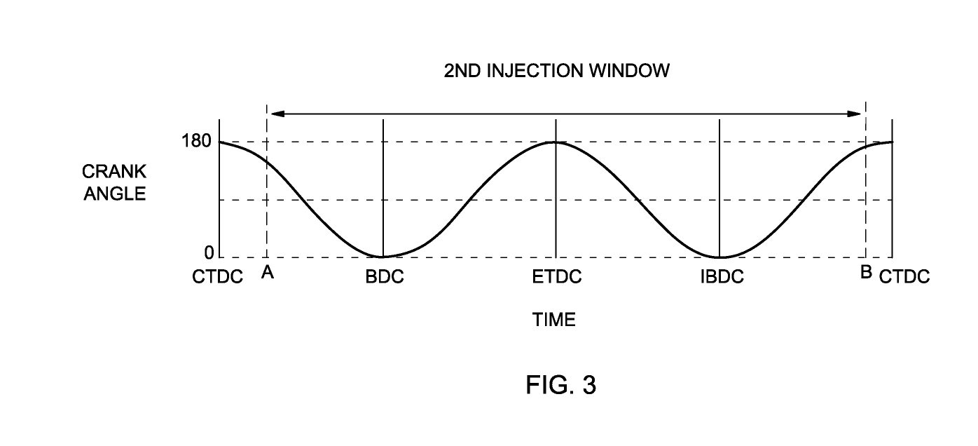

FIG. 3 is a graphical representation of the piston position as a function of time during a four stroke cycle and depicts the timing of the first injection step and second injection step performed in accordance with the principles of the present invention. As shown in FIG. 3, the position of the piston is generally depicted along a sign wave configuration. At time zero the piston is located at compression top dead center (CTDC) representing a crank angle of 180°. In a typical diesel engine, the injection of fuel within the combustion chamber begins at about compression top dead center for a defined period of time to initiate combustion when the piston is at or slightly past compression top dead center (CTDC). After combustion, the piston will reach bottom dead center (BDC) depicted at a time when the crank angle is at 0°. As the piston continues during its cycle, it will reach exhaust top dead center (ETDC). Where the crank angle again reaches 180°. As the piston continues during its cycle, the stroke will enter the intake phase and the piston will reach intake bottom dead center (IBDC) during which time air is allowed to enter the intake valve of the cylinder. At this point, the crank angle is again at 0°. As the piston enters the compression stroke, it will eventually reach compression top dead center again where fuel may again be injected into the cylinder. Combustion is initiated at or slightly after compression top dead center (CTDC) thereby starting a new piston cycle.

As shown in FIG. 3, in accordance with the principles of the present invention, the second injection step, whereby the fuel additive is injected into the cylinder to reach the cylinder walls, may occur after the first injection step. The second injection step may occur at a time between 40° after compression top dead center, represented by “A” in FIG. 3, and 10° before compression top dead center, represented by “B” shown in FIG. 3. During this window of time, the additive may be injected into the cylinder during the second injection step to allow the additive to reach the cylinder walls and thereby provide and fuel economy benefits. The first injection step is generally performed at a time which will initiate combustion of fuel within any diesel engine, as is well known in the art. Generally, this first injection step occurs between time “B” and “A”, namely, between 10° before compression top dead center and 40° after compression top dead center.

In order to achieve the benefits of increased friction modification and fuel economy, the second injection step need not necessarily be performed during each piston cycle. For example, it is believed that the delivery of approximately 1 gram of fuel additive to the cylinder wall during each hour of engine operation will achieve the benefits of increased friction modification and fuel economy. In addition, it is believed that performing the second injection step during the early stages of the intake stroke will maximize the amount of fuel additive reaching the cylinder wall. The more fuel additive reaching the cylinder wall, the greater the increase in friction modification and fuel economy benefits for any fuel additive injected into the cylinder. Fuel additive injected into the cylinder, but not reaching the cylinder wall, will not achieve the benefits of the present invention.

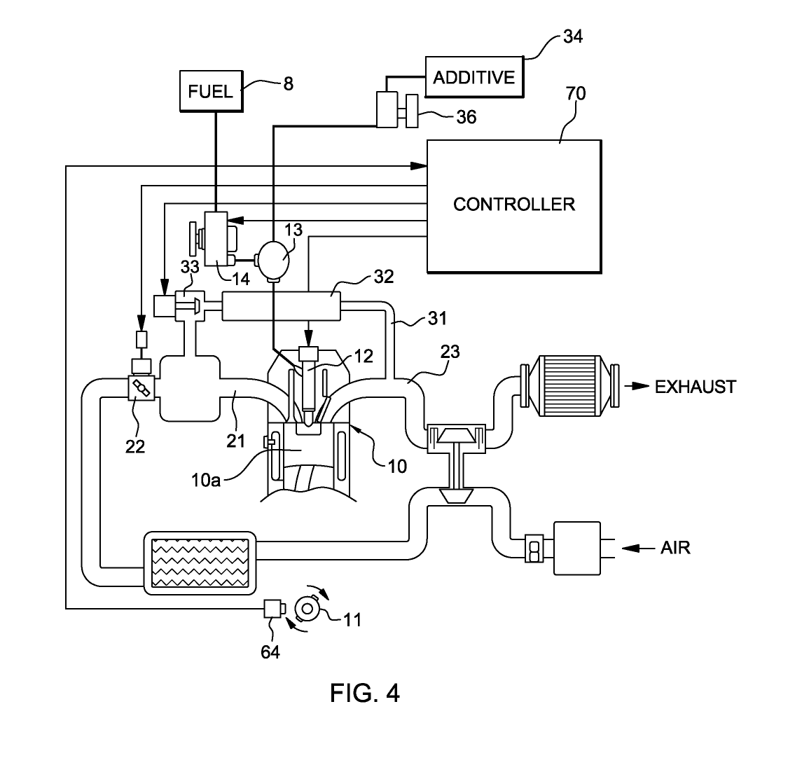

FIG. 4 depicts a schematic representation of an alternative embodiment of a system for enhancing the fuel economy of a diesel engine in accordance with the principles of the present invention. The system as shown in FIG. 4, is the same as that shown in FIG. 1 except that the additive is not mixed with the fuel within the fuel tank. In this embodiment, fuel is stored in a fuel tank 8 and the additive is stored, without fuel, in a separate additive reservoir 34. Additive reservoir 34 is in fluid communication with a fuel additive pump 36, which is in fluid communication with common rail 13. In this embodiment, the additive pump 36 pumps additive from the additive reservoir 34 into the common rail 13. Other means, other than a dedicated pump, of transporting the additive may be employed such as a venturi. The mixture of fuel and additive within the common rail 13 is then injected into the cylinder 10 by the fuel injector 12 to perform the second injection step as previously described herein.

The controller 70 may control the additive pump 36, and a sensor (not shown) may be included with the fuel additive reservoir 34 to sense the presence or absence of additive therein. Accordingly, the controller 70 may control the amount of fuel additive, if present in the fuel additive reservoir 34, from being pumped into the common rail 13 by fuel additive pump 36.

Using the system and embodiment of FIG. 4, the concentration of fuel additive within the fuel in common rail 13 may be controlled and varied from anywhere between a zero concentration to near 100% additive. This allows the amount of fuel additive to be used with the second injection step, as previously described herein, to be precisely controlled. It may be preferable to use an amount of additive in the second injection step, which results in a high concentration of additive within the fuel. Such a concentration allows the engine to maximize the amount of additive reaching the cylinder wall and also minimizing the amount of fuel reaching the cylinder wall. The controller 70 may thus allow the fuel additive pump 36 to pump an amount of additive within the common rail 13 so that the amount of fuel within the second injection step is less than the fuel within the first injection step. For example, 10% of the fuel may be used in the second injection step compared to the first injection step.

In addition, in any of the embodiments shown herein, the controller 70 may control the frequency of the second injection step. For example, the second injection step need not be performed for every piston cycle. The second injection step may occur during multiple consecutive piston cycles for a defined period of time and then the second injection step may be eliminated for a defined period of time of engine operation. The second injection step may be used, for example, for up to approximately 30 seconds or more of engine operation and then stopped for approximately 10 minutes or more of engine operation. Such periodic implementation of the second injection step may be sufficient to provide the benefits of increased lubricity and fuel economy within diesel engines.

Such benefits may be achieved when, for example, a particular amount of fuel additive reaches the cylinder wall during a particular time of engine operation. Thus, the invention can be implemented by using multiple second injection steps for a particular time period, or a single injection step for the same time period, so that a particular aggregate amount of additive injected within such time period sufficient to provide enhanced fuel economy is used. For example, for each cylinder of a diesel engine, it is believed that one gram of fuel additive reaching a cylinder wall during one hour of engine operation will provide the benefits of increased friction modification in fuel economy. Therefore, the system of the present invention may be implemented to perform the second injection step in any selective pattern or frequency which will achieve the desired amount of fuel additive reaching the cylinder wall during each hour, or other time component, of engine operation.

It should be understood that the embodiments set forth herein are illustrative and that various modifications may be made to the disclosure herein without departing from the invention. For example, variations set forth herein may be modified without departing from the scope of the invention.

What is claimed is:

1. A method of enhancing the fuel economy of a diesel engine of the type wherein each cylinder undertakes four strokes during a cycle, the method comprising:
performing a first injection step by injecting diesel fuel into a cylinder of a diesel engine to initiate combustion of said fuel within said cylinder;
performing a second injection step by injecting an additive into the cylinder during said cycle at a time different than said first injection step wherein fuel additive reaches the cylinder wall; and
repeating said first injection step and said second injection step during a different cycle to improve the fuel economy of said diesel engine.

2. The method of claim 1 wherein the second injection step occurs between a time after said cylinder passes 40° after compression top dead center and a time prior to when said cylinder is located at 10° before compression top dead center.

3. The method of claim 2 wherein the additive comprises a fatty acid based alkanolamide produced from the reaction of an alkanolamine with one or more of a natural or synthetic fatty based oil, fatty based acid and fatty based ester.

4. The method of claim 2 wherein the second injection step comprises injecting said additive when said additive is mixed within fuel.

5. The method of claim 4 wherein the second injection step is not repeated during consecutive engine cycles for a predetermined period of time.

6. The method of claim 2 wherein said additive is stored in an additive reservoir.

7. The method of claim 5 wherein second injection step is repeated after about at least 10 minutes of engine operation.

8. A system for enhancing the fuel economy of a diesel engine of the type wherein each cylinder undertakes four strokes during a cycle, and of the type having means for performing a first injection step by injecting diesel fuel into a cylinder of a diesel engine to initiate combustion of said fuel within said cylinder, the system comprising:
means for performing a second injection step by injecting an additive into the cylinder during said cycle at a time different than said first injection step wherein additive reaches the cylinder wall; and
means for repeating said first injection step and said second injection step during a different cycle to improve the fuel economy of said diesel engine.

9. The system of claim 8 wherein the second injection step occurs at a time after said cylinder passes 40° after compression top dead center and at a time prior to when said cylinder is located at 10° before compression top dead center.

10. The system of claim 9 wherein the additive comprises a fatty acid based alkanolamide produced from the reaction of an alkanolamine with one or more of an natural or synthetic fatty based oil, fatty based acid and fatty based ester.

11. The system of claim 9 wherein the second injection step comprises injecting said additive when said additive is mixed within fuel.

12. The system of claim 11 wherein the second injection step is not repeated during consecutive engine cycles for a predetermined period of time.

13. The system of claim 8 further comprising an additive reservoir separate from a fuel tank.

14. The system of claim 12 wherein second injection step is repeated for a plurality of consecutive cycles after about at least about 10 minutes of engine operation.

15. A diesel engine of the type wherein each cylinder undertakes four strokes during a cycle, the engine comprising:
an engine block having a plurality of cylinders therein;
means for performing a first injection step by injecting diesel fuel into at least one of said cylinders to initiate combustion of said fuel within said cylinder near the end of a compression stroke of said cycle;
means for performing a second injection step by injecting an additive into the cylinder during said cycle at a time different than said first injection step to allow said additive to reach the cylinder wall; and
means for repeating said first injection step and said second injection step during a different cycle to improve the fuel economy of said diesel engine.

16. The engine of claim 15 wherein the second injection step occurs between a time after said cylinder passes 40° after compression top dead center and a time prior to when said cylinder is located at 10° before compression top dead center.

17. The engine of claim 16 wherein the second injection step comprises injecting said additive when said additive is mixed within fuel.

18. The engine of claim 3 wherein the second injection step is not repeated during consecutive engine cycles.

19. The engine of claim 18 wherein second injection step is repeated for a plurality of consecutive cycles after about at least 10 minutes of engine operation.

20. The engine of claim 15 wherein the additive comprises a fatty acid based alkanolamide produced from the reaction of an alkanolamine with one or more of an natural or synthetic fatty based oil, fatty based acid and fatty based ester.

21. The engine of claim 15 further comprising an additive reservoir separate from a fuel tank.
